(19) United States
(12) Patent Application Publication
(10) Pub. No.: US 2016/0121474 A1
(43) Pub. Date: May 5, 2016

(54) Handheld Machine-Tool Device

(71) Applicant: Robert Bosch GmbH, Stuttgart (DE)

(72) Inventor: Andre Ullrich, Leinfelden-Echterdingen (DE)

(21) Appl. No.: 14/921,625

(22) Filed: Oct. 23, 2015

(30) Foreign Application Priority Data
Oct. 31, 2014 (DE) 10 2014 222 253.2

(51) Int. Cl. B25F 5/00

(52) U.S. Cl. CPC B25F 5/001

(57) ABSTRACT

A handheld machine-tool device has at least one gear unit, which has a drive element configured for pure rotational movement, and an output element configured for pure rotational movement, and which is configured to convert rotational speed and/or torque between the drive element and the output element. The gear unit has an eccentric element, which is configured to operate in at least one operating state to translate pure rotational movement of the drive element into eccentric movement in order to drive the output element.

This application claims priority under 35 U.S.C. §119 to German patent application no. 10 2014 222 253.2, filed Oct. 31, 2014 in Germany, the disclosure of which is incorporated herein by reference in its entirety.

### BACKGROUND

A handheld machine-tool device includes at least one gear unit, which has a drive element intended for a pure rotational movement, which has an output element intended for a pure rotational movement, and which is intended for a conversion of rotational speed and/or torque between the drive element and the output element, has already been proposed.

### SUMMARY

The disclosure proceeds from a handheld machine-tool device having at least one gear unit, which has a drive element intended for a pure rotational movement, which has an output element intended for a pure rotational movement, and which is intended for a conversion of rotational speed and/or torque between the drive element and the output element.

It is proposed for the gear unit to have an eccentric element, which is intended in at least one operating state to translate a pure rotational movement of the drive element into an eccentric movement in order to drive the output element.

A quick rotational movement can thus be translated into a slower rotational movement in a particularly efficient manner. A particularly compact and particularly lightweight gear unit can be intended. An available installation space can be utilized particularly advantageously.

A “handheld machine-tool device” is to be understood in this context to mean in particular a device for an electric handheld machine tool, preferably a drill or another machine appearing expedient to a person skilled in the art, with which, in an operating state, a torque and/or a rotational movement is converted into a drive of a tool. A “gear unit” is to be understood in this context to mean in particular a transmission unit with a transmission ratio greater than 1.5. The handheld machine-tool device preferably has merely one transmission unit. A “pure rotational movement” of an element is to be understood to mean a rotational movement centered with respect to an intended axis of rotation. The element preferably rotates fully a number of times, i.e. the rotational movement has the same direction of rotation for a plurality of revolutions. Trajectories of points on the element in each case preferably describe closed circles concentric with one another, of which the center points each lie on the axis of rotation. A “drive element” is to be understood in this context to mean in particular an element that is connected to a drive unit of the handheld machine-tool device in order to drive the gear unit. An “output element” is to be understood in this context to mean in particular an element that is connected to a tool receptacle of the handheld machine-tool device in order to transfer a torque and/or a rotational movement. An “eccentric movement” of an element is to be understood in this context to mean in particular a movement in translation, with which trajectories of the points of the element describe circles of equal size having different center points. The term “intended” is to be understood to mean in particular especially designed and/or equipped. The fact that an object is intended for a specific function is to be understood to mean in particular that the object satisfies and/or performs this specific function in at least one state of application and/or operation.

The gear unit advantageously comprises a transfer element, which in the operating state translates the eccentric movement into a pure rotational movement of the output element. A gear unit having a small number of parts can thus be provided, whereby a low susceptibility to faults can be achieved. A gear unit having a long service life can be provided. An economical gear unit can be provided. A “transfer element” is to be understood in this context to mean in particular an element that is arranged between the drive element and the output element with respect to a flow of force. The transfer element preferably cooperates directly with the drive element and with the output element. The transfer element itself is preferably intended at least for an eccentric movement.

It is also proposed for the gear unit to comprise at least one rolling bearing, which supports the transfer element rotatably relative to the eccentric element. A particularly low-friction torque transfer can thus be achieved between the eccentric element and the transfer element. A robust bearing position can be formed, whereby a low-maintenance handheld machine tool having a long service life can be provided. It is also conceivable for the gear unit to have a sliding bearing, which supports the transfer element rotatably relative to the eccentric element, whereby a particularly compact point of support can be formed.

In an advantageous embodiment the gear unit comprises a supporting element, which in the operating state cooperates with the transfer element in order to translate the eccentric movement into the pure rotational movement. The eccentric movement may thus be translated into a pure rotational movement in a structurally simple manner. A gear unit with particularly low wear can be provided. The supporting element is preferably permanently in contact with the transfer element at least in one operating state, whereby a particularly uniform loading of the transfer element and of the supporting element can be achieved and a gear unit having a long service life can be provided. The handheld machine-tool device for a handheld machine tool is preferably provided with a housing. The supporting element is preferably rotationally fixed to the housing of the handheld machine tool and is provided in order to transfer a differential torque to the housing.

The gear unit is advantageously formed as a cycloidal gear. A cycloidal gear can thus be used particularly advantageously in a handheld machine-tool device. A particularly compact handheld machine-tool device can be provided. A “cycloidal gear” is to be understood in this context to mean in particular an eccentric gear, in which an eccentric element drives a transfer element, which is formed as a cam disc and rolls over a supporting element. The transfer element preferably has recesses, which are each intended for engagement of a driver element for a transfer of a rotary movement of the transfer element to an output element.

In advantageous embodiment the gear unit has a transmission ratio of at least 15:1. A particularly large torque can thus be achieved at the output element in relation to a torque at the drive element. A drive motor can be small. A particularly small and lightweight electric motor can be used for a drive. An economical handheld machine tool can be provided, and a high level of user comfort can be achieved. The transmission ratio is especially 20:1, preferably 80:1 and particularly preferably 100:1.

Handheld machine-tool device according to one of the preceding claims, characterized in that the gear unit comprises merely one gear stage. A required installation space can thus be made even smaller, and a particularly compact handheld machine tool can be provided. A structurally simple design can be achieved. A particularly manageable handheld machine tool can be provided, and the user comfort can be further increased. A “gear stage” is to be understood in this context to mean in particular a pair of gear elements, which cooperate with one another and of which the cooperation determines a transmission ratio. The transmission ratio is preferably greater than 1.5.

It is also proposed for the gear units to be intended for a rotational speed of at least 40,000 rpm. A gear unit that can be used in a particularly versatile manner can thus be provided. A “rotational speed of a gear unit” is to be understood in this context to mean in particular an input rotational speed, i.e. a rotational speed of the drive element.

The handheld machine-tool device advantageously comprises a drive unit that is intended, in one operating mode, for an idling rotational speed of at least 15,000 rpm. A drive unit with low torque, but high rotational speed can be used, and at the same time a high torque can be achieved at an insertion tool. A small electric motor can be used, and a particularly economical handheld machine tool can be provided. An “idling rotational speed” is to be understood in this context to mean in particular a rotational speed in an unloaded state of the drive unit, in which the output element can rotate freely apart from a bearing friction. The idling rotational speed is especially 20,000 RPM, preferably 40,000 rpm and particularly preferably 50,000 rpm.

A handheld machine tool, in particular a drill, having a handheld machine-tool device according to the disclosure is also proposed. A particularly compact and economical drill can thus be provided. A drill having a particularly long service life may also be provided.

The handheld machine-tool device according to the disclosure is not to be limited here to the above-described application and embodiment. In particular, the handheld machine-tool device according to the disclosure, in order to perform a function described herein, may have a number of individual elements, components and units deviating from a number specified herein.

### BRIEF DESCRIPTION OF THE DRAWINGS

Further advantages will emerge from the following description of a drawing. The drawing illustrates an exemplary embodiment of the disclosure. The drawing, the description and the claims contain numerous features in combination. A person skilled in the art will also consider the features individually wear appropriate and will combine them to give expedient further combinations.

In the drawing:

FIG. 1 shows a schematic side view of a handheld machine tool having a handheld machine-tool device, and

FIG. 2 shows a perspective view of a gear unit of the handheld machine-tool device.

### DETAILED DESCRIPTION

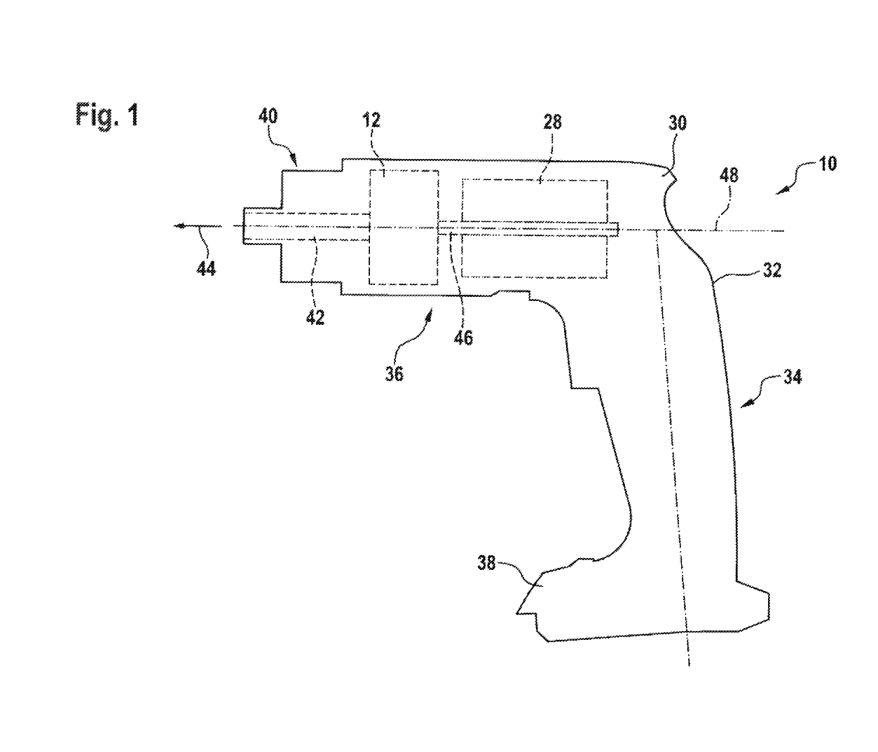

FIG. 1 shows a handheld machine tool 30, which is formed as a drill. The handheld machine tool 30 comprises a housing 32, which has a grip portion 34 and a drive portion 36. The grip portion 34 and the drive portion 36 each have an axis, said axes enclosing an angle of approximately 95° with one another. The angle may also assume a different value appearing expedient to a person skilled in the art. The handheld machine tool 30 is intended for one-handed or two-handed operation. The grip portion 34 in the present exemplary embodiment has a foot 38 at one end.

The handheld machine tool 30 comprises a drive unit 28 with an electric motor. The handheld machine tool 30 also comprises a handheld machine-tool device 10 with a gear unit 12. The gear unit 12 has a drive element 14, which is intended for a pure rotational movement, and an output element 16, which is intended for a pure rotational movement. The drive element 14 is intended for a plurality of successive, complete revolutions. The output element 16 is intended for a plurality of successive, complete revolutions. The gear unit 12 is intended for a conversion of rotational speed and/or torque between the drive element 14 and the output element 16. The handheld machine-tool device 10 comprises an output unit 40 having an output shaft 42 and a tool receptacle (not illustrated in greater detail) connected to the output shaft 42 for an insertion tool, such as a drill bit, a screwdriver blade, a stirrer or an abrasive tool. The handheld machine tool 30 has a primary working direction 44. The drive unit 28, the handheld machine-tool device 10 with the gear unit 12, and the output unit 40 are arranged in succession along the primary working direction 44.

The handheld machine-tool device 10 comprises a drive shaft 46, which is intended to connect the drive element 14 of the gear unit 12 to the drive unit 28 in order to transfer a torque and/or a rotational movement. It is conceivable for the drive element 14 to be connected integrally to the drive shaft 46. The handheld machine tool 30 has a drive axis 48. The drive shaft 46 and the output shaft 42 are arranged in line with one another over the drive axis 48.

The gear unit 12 has an eccentric element 18, which is intended in at least one operating state to translate a pure rotational movement of the drive element 14 into an eccentric movement in order to drive the output element 16. The drive element 14 and the output element 16 have a common axis of rotation. The eccentric element 18 is rotationally fixed to the drive element 14. The eccentric element 18 has an eccentric shaft 50 and an eccentric disc 52. In the present exemplary embodiment the drive element 14 is connected integrally to the eccentric shaft 50. The eccentric shaft 50 is arranged coaxially with the drive axis 48. The eccentric disc 52 is circular and is arranged eccentrically on the eccentric shaft 50, i.e. the eccentric shaft 50 and the eccentric disc 52 each have an axis of symmetry, and the axes of symmetry are arranged parallel to one another and at a distance from one another. The eccentric disc 52 is arranged eccentrically relative to the drive axis 48.

The gear unit 12 comprises a transfer element 20, which in the operating state translates the eccentric movement into a pure rotational movement of the output element 16. The transfer element 20 is disc-shaped. The transfer element 20 is formed as a cam disc and on an outer periphery has a plurality of cam portions 54.

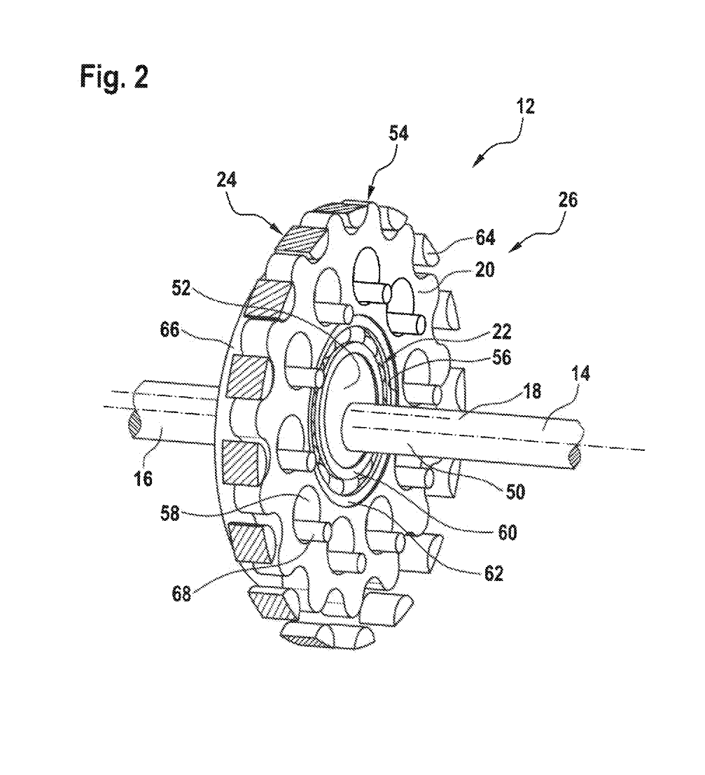

The cam portions 54 are formed similarly to one another and each have a concave and a convex sub-portion. In FIG. 2 one cam portion 54 is provided with a reference sign by way of representation. The cam portions 54 are arranged directly adjacently to one another along a peripheral direction on the outer periphery. In the present exemplary embodiment the transfer element 20 has fifteen cam portions 54. The sub-portions in the present exemplary embodiment are shaped at least substantially in the form of an arc of a circle.

The transfer element 20 has a central circular recess 56. The transfer element 20 has a tip circle. The tip circle and the circular recess 56 are arranged concentrically with one another. The tip circle and the circular recess 56 each have a center point that is arranged on an axis of symmetry of the transfer element 20. In a mounted state the axis of symmetry is arranged eccentrically relative to the drive axis 48 of the drive shaft 46.

In the mounted state the eccentric disc 52 is arranged in the recess 56 of the transfer element 20. The eccentric disc 52 is mounted rotatably in the transfer element 20. The transfer element 20 and the eccentric disc 52 are arranged in the same plane. The transfer element 20 in the mounted state surrounds the eccentric disc 52 of the drive element 14. In the present exemplary embodiment the eccentric disc 52 and the transfer element 20 have at least substantially the same axial extension. The transfer element 20 and the eccentric disc 52 are arranged in an axially overlapping manner. It is conceivable for the eccentric disc 52 and the transfer element 20 to have different axial extensions. The axis of symmetry of the eccentric disc 52 and the axis of symmetry of the transfer element 20 coincide in the mounted state. The eccentric disc 52 and the transfer element 20 are arranged concentrically with one another. The transfer element 20 is arranged eccentrically, with respect to the axis of the eccentric shaft 50, in the mounted state.

The transfer element 20 has a plurality of further recesses 58. The transfer element 20 in the present exemplary embodiment 10 has further recesses 50. The further recesses 58 are each circular. The further recesses 58 are formed similarly to one another. One of the further recesses 58 is provided in FIG. 2 with a reference sign by way of representation. The further recesses 58 are each arranged at the same distance from the axis of symmetry of the transfer element 20 and are distributed uniformly in a peripheral direction. The further recesses 56 are intended for a transfer of a torque and/or of a rotational movement to the output element 16. The further recesses 58 each have the same diameter, which corresponds to an eccentricity of the eccentric disc 52 with respect to the eccentric shaft 50.

The gear unit 12 comprises a rolling bearing 22, which supports the transfer element 20 rotatably relative to the eccentric element 18. The rolling bearing 22 supports the eccentric disc 52 of the eccentric element 18 and the transfer element 20 rotatably relative to one another. The rolling bearing 22 comprises an inner ring 60, which is rotationally fixed to the eccentric disc 52, and an outer ring 62, which is rotationally fixed to the transfer element 20. In the present exemplary embodiment the rolling bearing 22 is formed as a ball bearing. The rolling bearing 22 has a plurality of identical rolling elements, which in the present exemplary embodiment are formed as balls. It is also conceivable for the rolling elements to have a different form appearing expedient to a person skilled in the art and for example to be formed as cylindrical rollers, needles or tapered rollers.

The gear unit 12 comprises a supporting element 24, which in the operating state cooperates with the transfer element 20 in order to translate the eccentric movement into the pure rotational movement. The supporting element 24 in the present exemplary embodiment is formed as an internal gear. The internal gear is arranged fixed to the housing. In a mounted state a center point of the supporting element 24 is arranged on the drive axis 48. The supporting element 24 has a plurality of radial protrusions 64. The protrusions 64 are directed radially inwardly. The radial protrusions 64 in the operating state cooperate with the cam portions 54 of the transfer element 20. The cam portions 54 of the transfer element 20 are each engaged, in a region of the outer periphery of the transfer element 20, with the radial protrusions 64 of the supporting element. The supporting element 24 in the operating state transfers a torque to the transfer element 20. In the present exemplary embodiment the supporting element 24 has sixteen radial protrusions 64. A number of radial protrusions 64 of the supporting element 24 is greater by one than a number of the cam portions 54 of the transfer element 20.

The output element 16 of the gear unit 12 comprises a driver disc 66. The driver disc 66 is circular and in a mounted state is arranged coaxially with the drive axis 48. The driver disc 66 has a disc plane. The driver disc 66 is rotationally fixed to the output shaft 42. The output element 16 has a plurality of driver elements 68.

The driver elements 68 are formed in the present exemplary embodiment as pins. The pins are arranged on the driver disc 66 in the direction of the drive axis 48, perpendicularly to the disc plane of the driver disc 66. The driver elements 68 are each arranged at the same distance from an axis of the driver disc 66. The driver elements 68 are distributed uniformly in the peripheral direction. The driver elements 68 formed similarly to one another. One of the driver elements 68 is provided with a reference sign by way of representation. In the present exemplary embodiment the driver elements 68 are formed integrally with the driver disc 66. It is conceivable for the driver elements 68 to be formed separately from the driver disc 66 and to be fixedly connected to the driver disc 66. It is also conceivable for the driver elements 68 to be mounted rotatably in the driver disc 66. In a mounted state the driver elements 68 engage with the further recesses 58 of the transfer element 20. The further recesses 58 of the transfer element 20 are formed as receiving openings for the driver elements 68. A number of the driver elements 68 corresponds to a number of the further recesses 58 of the transfer element 20.

The gear unit 12 of the handheld machine-tool device 10 is formed as a cycloidal gear 26. In one operating state the drive shaft 46 rotates the drive element 14, which performs a pure rotational movement. The drive element 14 transfers the rotational movement to the eccentric element 18 having the eccentric disc 52. The eccentric disc 52 drives the transfer element 20. At least one cam portion 54 at the outer periphery of the transfer element 20 is in contact with a protrusion 64 of the supporting element 24, whereby the transfer element 20 superimposes an eccentric movement with a rotational movement. The transfer element 20 rolls over the supporting element 24. A direction of rotation of the transfer element 20 is directed oppositely to a direction of rotation of the drive element 14. The driver elements 68 are each in contact with an edge of the further recesses 58, which transfer the rotational movement of the transfer element 20 to the driver elements 68. The driver elements 68 transfer rotational movement to the driver disc 66, which is rotationally fixed to the output element 16. The driver disc 66 performs a pure rotational movement. The output element 16 performs a pure rotational movement.

The gear unit 12 has a transmission ratio of 15:1, i.e. 15 revolutions of the drive element 14 are translated in each case into one revolution of the output element 16. A direction of rotation of the drive element 14 is reversed. The gear unit 12 comprises just one gear stage. The gear stage at least substantially defines the transmission ratio between the drive element 14 and the output element 16 and therefore also between the drive shaft 46 and the output shaft 42.

The gear unit 12 is intended for a rotational speed of at least 40,000 rpm. The gear unit 12 is intended for a rotational speed of the drive element 14 of at least 40,000 rpm. The drive unit 28 is intended, in one operating mode, for an idling rotational speed of at least 15,000 rpm.

What is claimed is:

1. A handheld machine-tool device, comprising:
at least one gear unit having (i) a drive element configured for pure rotational movement, and (ii) an output element configured for pure rotational movement,
wherein the at least one gear unit is configured for a conversion of rotational speed and/or torque between the drive element and the output element, and
wherein the gear unit has an eccentric element, which is configured to operate in at least one operating state to translate pure rotational movement of the drive element into eccentric movement in order to drive the output element.

2. The handheld machine-tool device according to claim 1, wherein the gear unit comprises a transfer element, which in the at least one operating state translates eccentric movement into pure rotational movement of the output element.

3. The handheld machine-tool device according to claim 2, wherein the gear unit comprises at least one rolling bearing configured and arranged to support the transfer element rotatably relative to the eccentric element.

4. The handheld machine-tool device according to claim 2, wherein the gear unit further comprises a supporting element, which in the at least one operating state cooperates with the transfer element in order to translate the eccentric movement into the pure rotational movement.

5. The handheld machine-tool device according to claim 1, wherein the gear unit is formed as a cycloidal gear.

6. The handheld machine-tool device according to claim 1, wherein the gear unit has a transmission ratio of at least 15:1.

7. The handheld machine-tool device according to claim 1, wherein the gear unit comprises only one gear stage.

8. The handheld machine-tool device according to claim 1, wherein the gear unit is configured for a rotational speed of at least 40,000 rpm.

9. The handheld machine-tool device according to claim 1, further comprising a drive unit, which is configured to operate in one operating mode at an idling speed of at least 15,000 rpm.

10. A drill, comprising:
a handheld machine-tool device that includes at least one gear unit having (i) a drive element configured for pure rotational movement, and (ii) an output element configured for pure rotational movement,
wherein the at least one gear unit is configured for a conversion of rotational speed and/or torque between the drive element and the output element, and
wherein the gear unit has an eccentric element, which is configured to operate in at least one operating state to translate pure rotational movement of the drive element into eccentric movement in order to drive the output element.
